(19) United States
(12) Patent Application Publication
(10) Pub. No.: US 2023/0178285 A1
(43) Pub. Date: Jun. 8, 2023

(54) ENCLOSURE FOR ISOLATING TRANSFORMER CORE FROM WINDINGS

(71) Applicant: Murata Manufacturing Co., Ltd., Nagaokakyo-shi, Kyoto-fu (JP)

(72) Inventors: Lee FRANCIS, Milton Keynes (GB); Jamie HARBER, Milton Keynes (GB)

(21) Appl. No.: 17/926,199

(22) PCT Filed: Jun. 10, 2021
(86) PCT No.: PCT/US2021/036736

§ 371 Date: Nov. 18, 2022

Related U.S. Application Data
(60) Provisional application No. 63/041,435, filed on Jun. 19, 2020.

(51) Int. Cl. H01F 27/04; H01F 27/02; H01F 27/06; H01F 27/30; H01F 27/26

(52) U.S. Cl. CPC H01F 27/04; H01F 27/022; H01F 27/06; H01F 27/306; H01F 27/266

(57) ABSTRACT

A transformer assembly includes a transformer core, a cup that receives the transformer core, a lid that engages with the cup and covers the transformer core, and a winding wound around the cup and the lid. The cup and/or the lid include at least one hole through which the transformer core is exposed to an exterior of the cup and the lid when the lid is engaged with the cup.

### CROSS REFERENCE TO RELATED APPLICATIONS

This application claims the benefit of U.S. Provisional Patent Application No. 63/041,435 filed on Jun. 19, 2020. The entire contents of this application are hereby incorporated by reference.

In addition, U.S. Provisional Patent Application No. 63/041,299 filed on Jun. 19, 2020; and U.S. Provisional Patent Application No. 63/041,499 filed on Jun. 19, 2020 are hereby incorporated by reference.

### BACKGROUND OF THE INVENTION

### 1. Field of the Invention

The present invention relates to an enclosure that isolates a transformer core from windings of the transformer. More specifically, the present invention relates to a core cup that encloses the transformer core.

### 2. Description of the Related Art

FIGS. 13A-13E show a known transformer assembly 500 and a known electrical assembly 590. The transformer assembly 500 shown in FIGS. 13A-13E provides isolation of a transformer core 510 from transformer windings 520 by keeping the transformer core 510 at a neutral potential or a substantially neutral potential.

As shown in FIGS. 13A-13E, the transformer core 510 may be isolated from the transformer windings 520 by placing the transformer core 510 inside a cup 502. After placing the transformer core 510 inside the cup 502, as shown in FIG. 13A, the transformer core 510 is encapsulated or potted with an epoxy or a silicon material to secure the transformer core 510 within the cup 502, and a lid 503 is placed on the cup 502, as shown in FIGS. 13B and 13C. Subsequently, as shown in FIG. 13D, the transformer windings 520 are wound around the cup 502 and lid 503. The transformer windings 520 must be wound by hand. As shown in FIG. 13E, the transformer windings 520 are then soldered to corresponding pads 552 on a substrate 550. The transformer windings 520 must be hand soldered to the substrate 550.

The transformer windings 520 shown in FIGS. 13A-13E may include, for example, two primary transformer windings 520P (including one feedback winding), and one or two secondary transformer windings 520S. Each of the transformer windings 520 shown in FIGS. 13A-13E requires at least two separate connections to the substrate 550: a start connection and a finish connection. A center tap may also be provided for each of the transformer windings.

In order to meet requirements set by UL standards for creepage from the transformer core 510 to the transformer windings 520 and from the primary transformer winding 520P to the secondary transformer winding 520S, a center isolation barrier 501 is provided in the cup 502 shown in FIGS. 13A-13E. In addition, a center diameter of a hole through the cup 502 and the lid 503 that includes the center isolation barrier 501 shown in FIGS. 13A-13E is about 2 mm, and the center isolation barrier 501 fills a majority of the space defined by the center hole through the cup 502 and the lid 503. Accordingly, hand winding is required for the transformer windings 520 shown in FIGS. 13A-13E, which is costlier and slower than machine winding. In addition, manufacturing efficiency is limited due to the requirement that the transformer core 510 be encapsulated or potted prior to the transforming windings 520 being wound around the cup 502 and the lid 503.

Furthermore, since the transformer core 510 is encapsulated or potted only inside the cup 502, and before the transformer windings 520 are wound around the cup 502 and lid 503, voids can be created in the encapsulant or potting. Accordingly, there is a risk that the transformer core 510 may break due to thermal expansion or the like. Although a second encapsulating or potting process may be performed after winding the transformer windings 520 or after the transformer assembly 500 is mounted to a substrate 550, performing additional encapsulating or potting processes reduces manufacturing efficiency and increases cost.

### SUMMARY OF THE INVENTION

To overcome the problems described above, preferred embodiments of the present invention provide transformer assemblies each with transforming windings that are able to be machine wound and a transformer core that is able to be encapsulated or potted after the transformer windings have been wound.

According to a preferred embodiment of the present invention, a transformer assembly includes a transformer core, a cup that receives the transformer core, a lid that engages with the cup and covers the transformer core, and a winding wound around the cup and the lid. The cup and/or the lid include at least one hole through which the transformer core is exposed to an exterior of the cup and the lid when the lid is engaged with the cup.

The transformer assembly can include a clip that is at least partially inserted into a center hole of the cup. The clip can include at least one clasp that engages with a recess of the cup. The clip can include a peg or a bracket that engages with a corresponding notch or recess in a substrate to secure the transformer assembly to the substrate. The clip can include an injection-molded plastic.

A bottom surface of the cup can include pips or feet that locate the transformer assembly to a substrate.

The transformer assembly can further include a substrate located in a center hole of the cup, where a material of the substrate can be FR4.

The at least one hole of the cup and/or the lid can be located in the cup and/or lid where the winding is wound around the cup and the lid.

Each of the cup and the lid can include a center hole with a diameter of about 4 mm or greater.

According to a preferred embodiment of the present invention, the transformer assembly is included in an electrical assembly. The electrical assembly further includes a substrate and a casing that at least partially surrounds the transformer assembly and the substrate. The transformer assembly is mounted to the substrate, and the winding includes first and second transformer windings that are electrically connected to corresponding pads on the substrate. The casing includes a material to encapsulate or pot the transformer assembly.

A method of assembling and mounting a transformer according to a preferred embodiment of the present invention includes placing a transformer core inside a cup, covering the transformer core with a lid, wrapping a primary transformer winding and a secondary transformer winding around the cup and the lid, mounting the cup to a substrate, and encapsulating or potting the transformer core after the cup has been mounted to the substrate.

The above and other features, elements, steps, configurations, characteristics, and advantages of the present invention will become more apparent from the following detailed description of preferred embodiments of the present invention with reference to the attached drawings.

### BRIEF DESCRIPTION OF THE DRAWINGS

FIG. 1 is a front perspective view of a transformer assembly including a clip.

FIG. 2 is a bottom perspective view of the transformer assembly shown in FIG. 1.

FIG. 3 is a front perspective view of the transformer assembly shown in FIG. 1 prior to the clip being inserted into the transformer assembly.

FIG. 4 is a bottom perspective view of the transformer assembly shown in FIG. 1 prior to the clip being inserted into the transformer assembly.

FIG. 5 is an exploded perspective view of the transformer assembly shown in FIG. 1.

FIG. 6 is a perspective view of a substrate to which the transformer assembly shown in FIG. 1 can be mounted.

FIG. 7 is a perspective view of an electrical assembly that includes the transformer assembly shown in FIG. 1 mounted to the substrate shown in FIG. 6.

FIGS. 8 and 9 are a perspective view and a side view of the electrical assembly shown in FIG. 7 inserted in a casing.

FIG. 10 is a perspective view of the electrical assembly and casing shown in FIG. 8 with alternative pins provided on the substrate.

FIGS. 11A and 11B show transformer windings and possible connections between the transformer assembly shown in FIG. 1 and a substrate.

FIG. 12 shows an example of pips or feet that may be provided on a bottom surface of the cup of the transformer assembly shown in FIG. 1.

FIGS. 13A-13E show a known transformer assembly and a known electrical assembly.

### DETAILED DESCRIPTION OF PREFERRED EMBODIMENTS

The following description is in all aspects illustrative and not restrictive and should not be construed to restrict the applications or uses of preferred embodiments of the present invention in any manner.

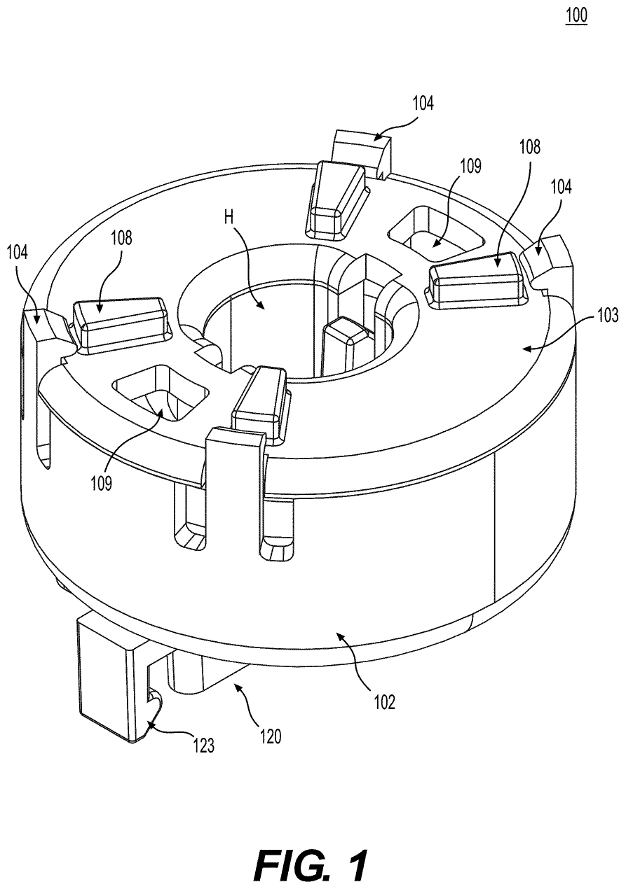

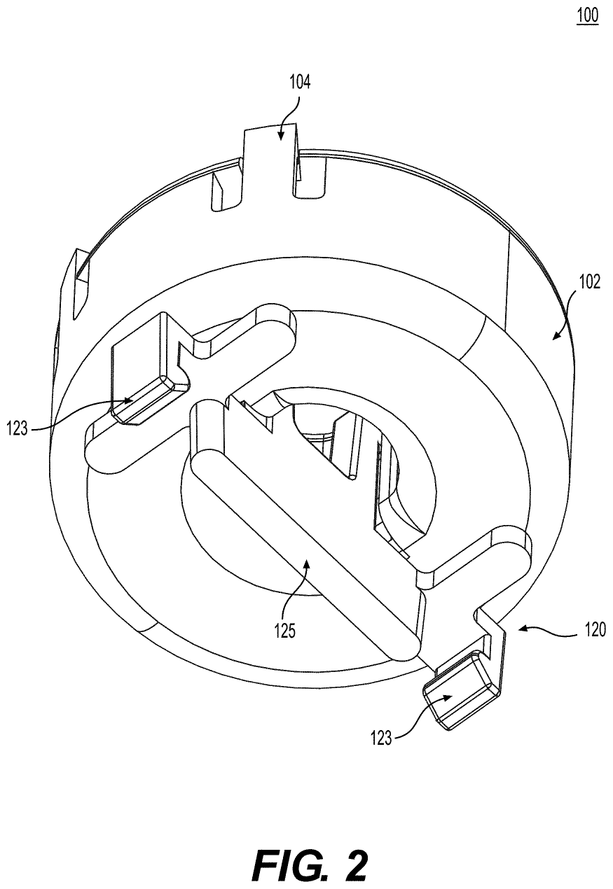

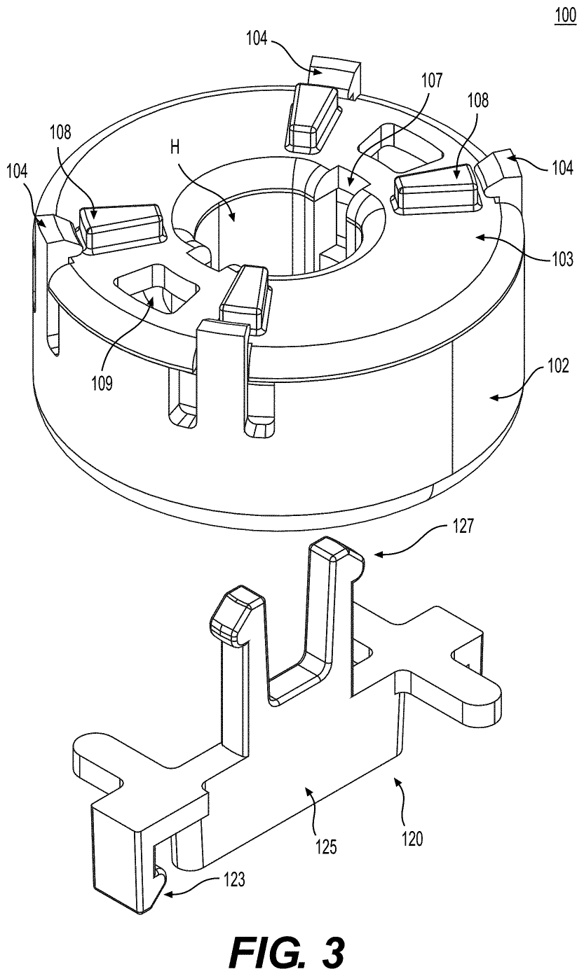

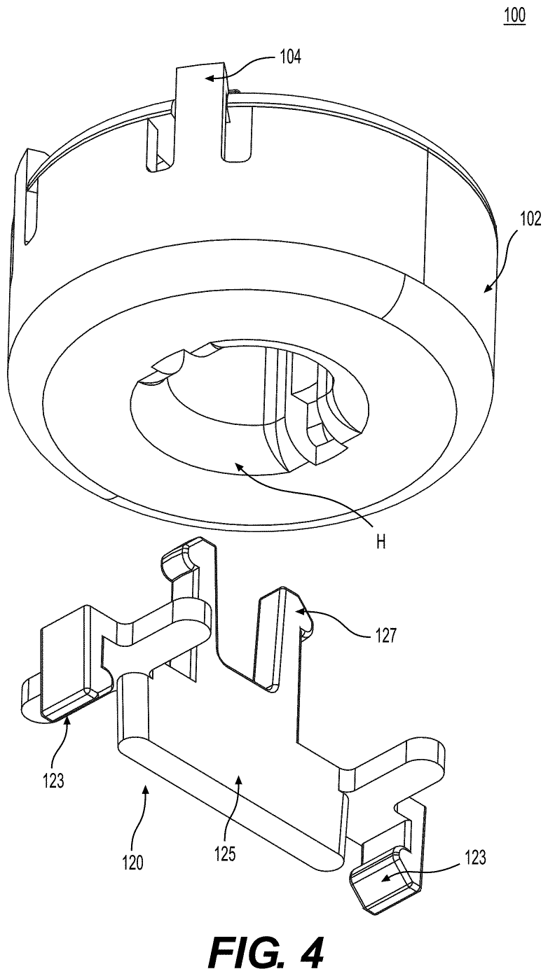

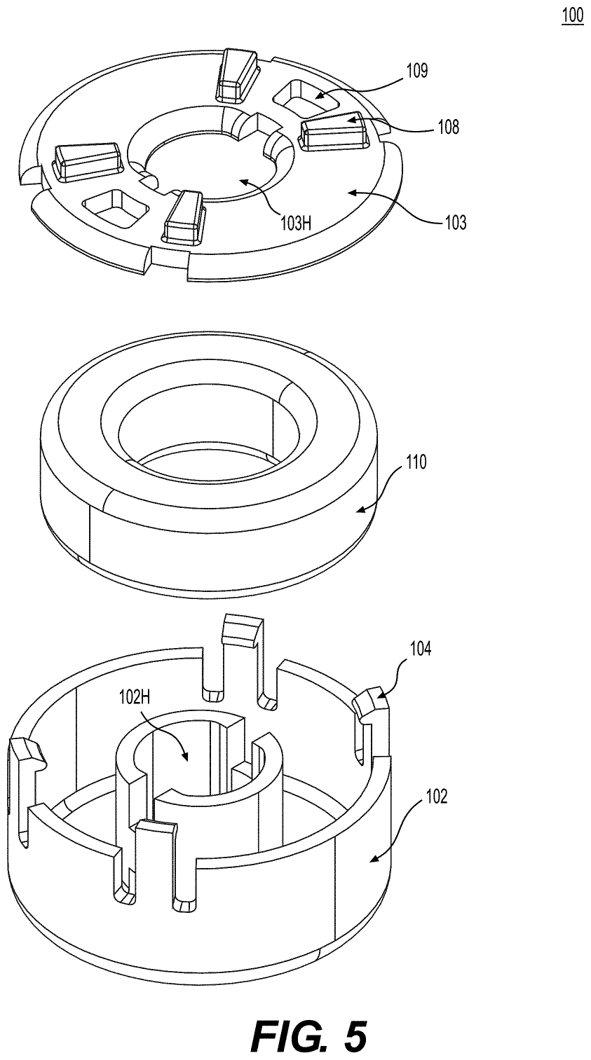

FIG. 1 is a front perspective view of a transformer assembly 100 including a clip 120. FIG. 2 is a bottom perspective view of the transformer assembly 100 shown in FIG. 1. FIG. 3 is a front perspective view of the transformer assembly 100 shown in FIG. 1 prior to the clip 120 being inserted into the transformer assembly 100. FIG. 4 is a bottom perspective view of the transformer assembly 100 shown in FIG. 1 prior to the clip 120 being inserted into the transformer assembly 100. FIG. 5 is an exploded perspective view of the transformer assembly 100 shown in FIG. 1.

As shown in FIGS. 1-5 and discussed further below, a transformer core 110 may be isolated from transformer windings by placing the transformer core 110 inside a cup 102. Both the transformer core 110 and the cup 102 have a toroidal or substantially toroidal shape. After placing the transformer core 110 inside the cup 102, a lid 103 is secured to the cup 102 by the fasteners 104 shown in FIGS. 1-5. A diameter of the cup 102 and lid 103 may be about 10 mm, for example. By securing the lid 103 in place with the fasteners 104, mechanical security of the transformer assembly 100 can be provided such that machine processing of the windings can be performed. Although four fasteners 104 are shown, the number of the fasteners 104 is not limited to four. In addition, alternative structures may be implemented to secure the lid 103 to the cup 102. For example, the lid 103 may be interference-fit to the cup 102, the lid 103 and the cup 102 may include corresponding recesses and pips that interlock, or a bayonet locking element of the lid 103 may be inserted into a recess provided in a wall of the cup 102. As an example, the cup 102 and the lid 103 may be an injection-molded plastic, for example, CRASTIN, diallyl phthalate (DAP), RYNITE, or the like.

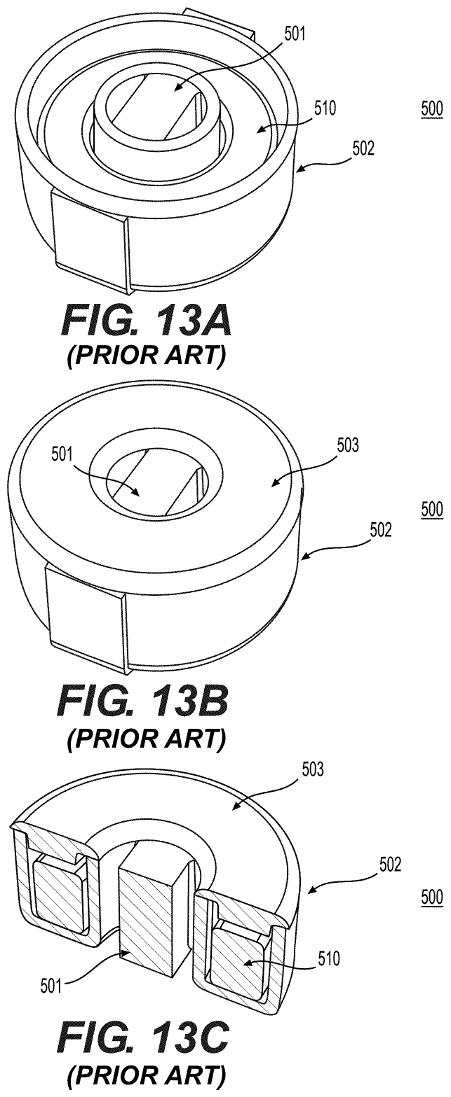

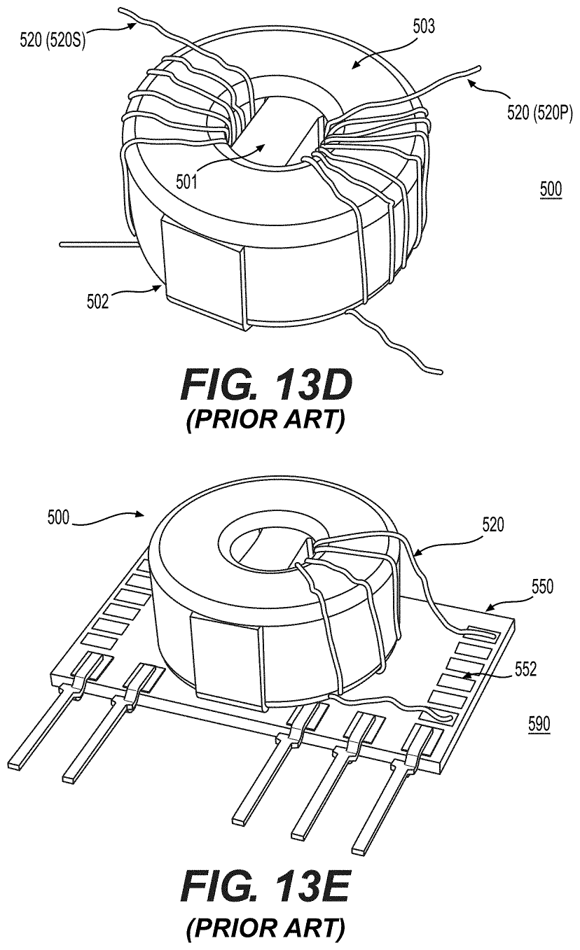

As compared to the known cup shown in FIGS. 13A-13E, the cup 102 in FIGS. 1-5 does not include a center isolation barrier. Accordingly, the cup 102 provides additional space in a center hole H to allow machine winding of the transformer windings.

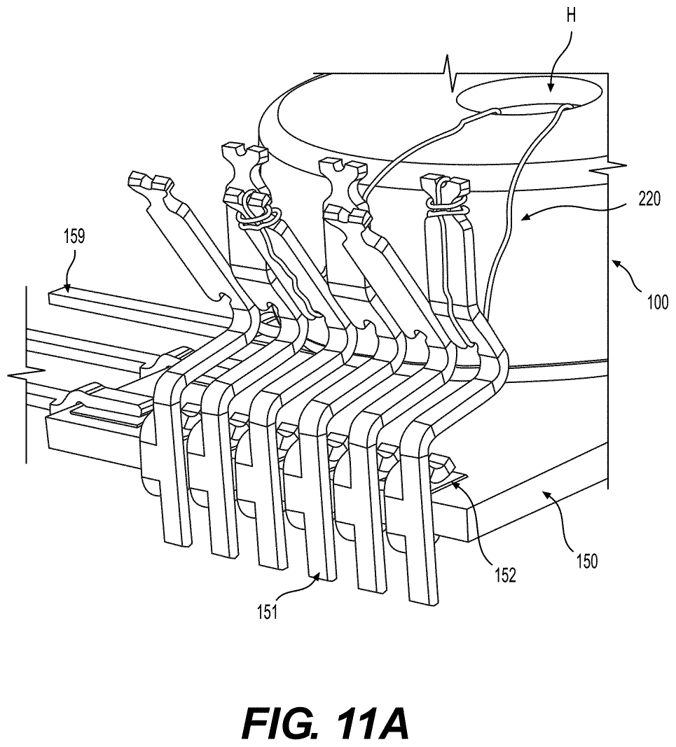

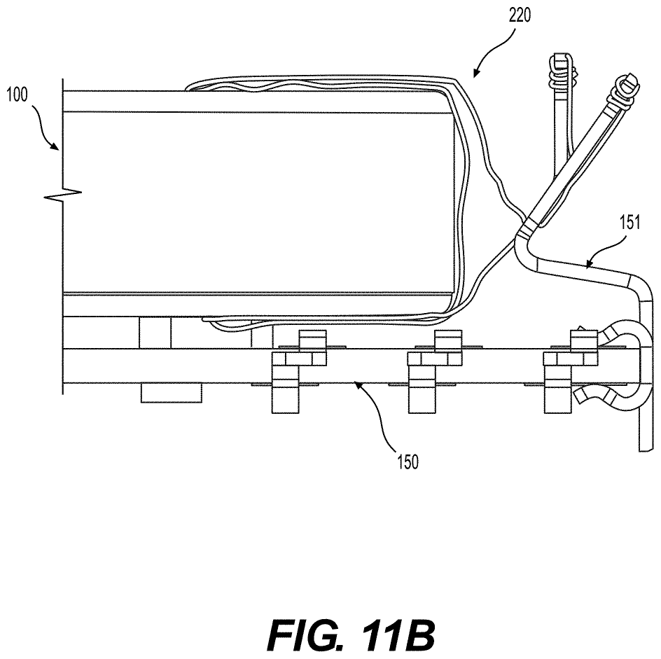

After securing the lid 103 to the cup 102, primary and secondary transformer windings 220 are wound around the cup 102 and lid 103, as discussed below. Both the cup 102 and the lid 103 include respective center holes 102H and 103H that define the center hole H, which accommodates the primary and secondary transformer windings 220. For example, a center diameter of the center holes 102H and 103H through the cup 102 and the lid 103 can be about 4 mm or greater so that machine winding may be used. However, the primary and secondary transformer windings 220 may also be hand wound. Examples of transformer windings 220 are shown in FIGS. 11A and 11B, which are discussed further below. The transformer windings 220 may include, for example, two primary transformer windings (including one feedback windings), and one or two secondary transformer windings. Each of the transformer windings 220 can include at least two separate connections to a substrate: a start connection and a finish connection. A center tap may also be provided for each of the transformer windings 220.

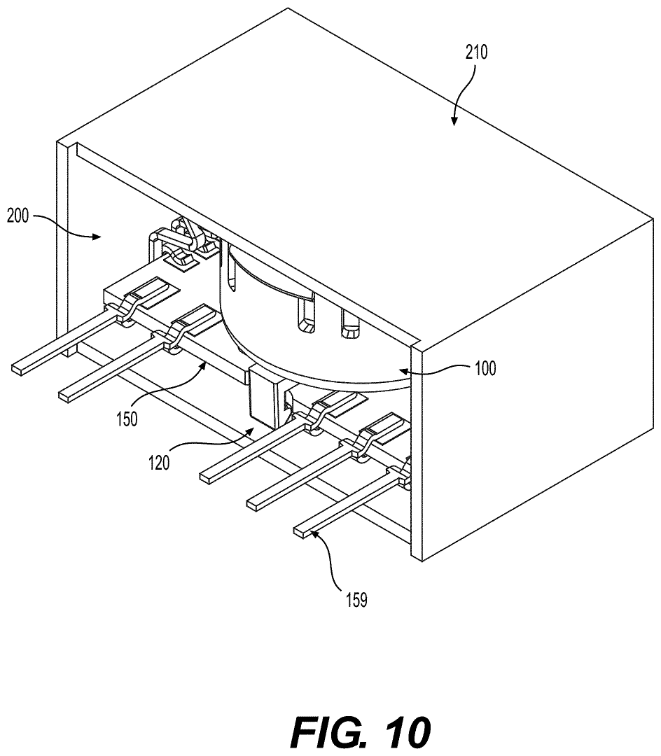

The lid 103 can include protrusions 108 that extend away from a top surface of the lid 103. As shown in FIGS. 1, 3, and 5, the lid 103 can have four protrusions 108, but any number of the protrusions 108 can be included. The protrusions 108 can be used to separate the transformer primary windings and the transformer secondary windings from each other. The protrusions 108 can abut against a bottom surface of the top of a casing 210 shown in FIGS. 8 and 10 to help locate and secure the transformer assembly 100 within the casing 210, particularly when the transformer assembly 100 is mounted to a substrate 150 to provide an electrical assembly, as discussed below.

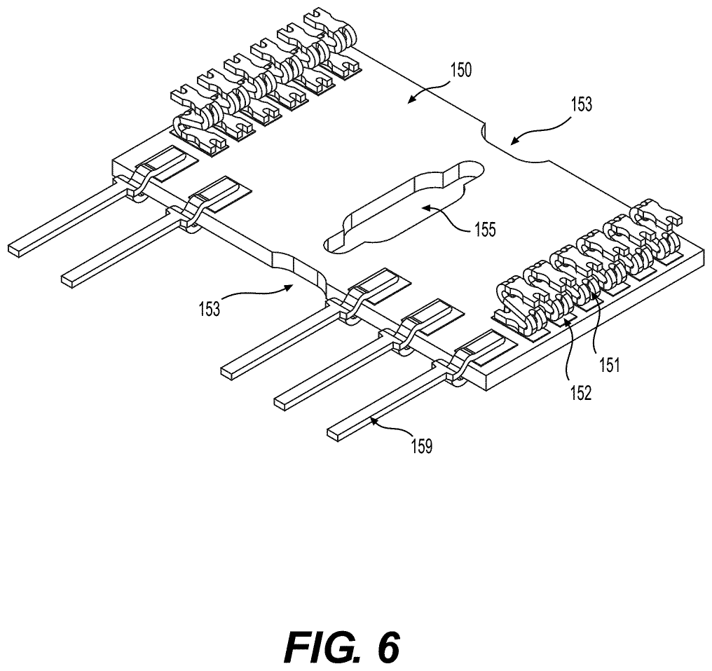

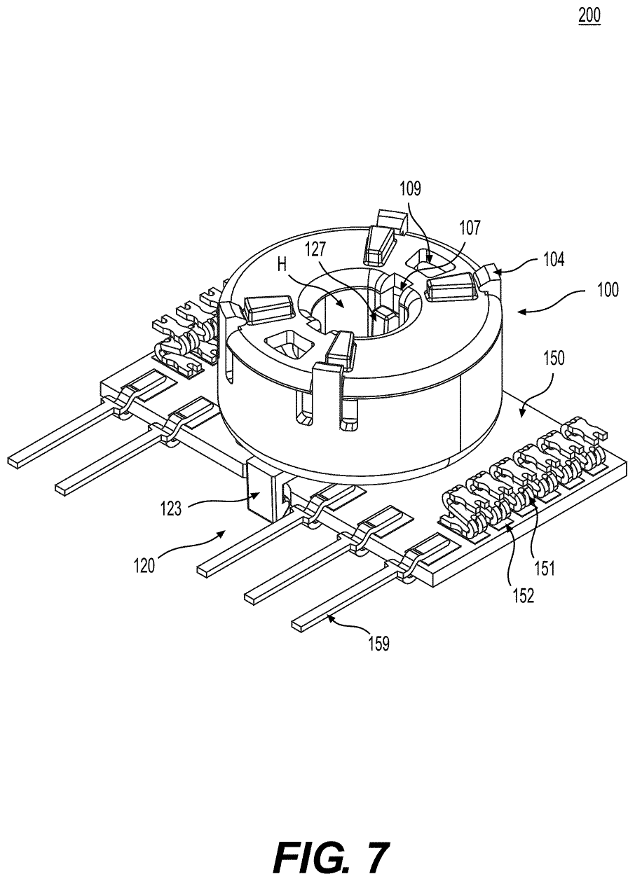

As shown in FIGS. 1-4, a clip 120 may then be inserted into the center hole H of the cup 102. The clip 120 includes clasps 127 that engage with corresponding recesses 107 in the cup 102 to secure the clip 120 to the cup 102. The clip 120 also includes a peg 125 and mounting brackets 123 to locate and secure the transformer assembly 100 to the substrate 150, as will be discussed with respect to FIGS. 6 and 7.

In addition to mounting, the clip 120 provides a physical barrier to ensure that the primary and secondary transformer windings 220 remain separated. The clip 120 also provides a minimum distance between the primary transformer windings and the secondary transformer windings. By providing a minimum distance between the primary transformer windings and the secondary transformer windings, increased electrical isolation is provided when the transformer assembly 100 is encapsulated or potted.

As an example, the clip 120 may be an injection-molded plastic, for example, CRASTIN, diallyl phthalate (DAP), RYNITE, or the like. In addition, the clip 120 may be implemented with other shapes, for example, a simple rectangular shape. It is also possible not to use the clip 120, and another suitable method of securing the transformer assembly 100 to the substrate 150 can be used. If the clip 120 is not used, then it is possible to insert a rectangular substrate, which could be made of, for example, FR4 or other suitable material, into the core 110 to improve isolation between the transformer primary windings and transformer secondary windings. The rectangular substrate may also extend through the substrate 150 on which the transformer assembly 100 is mounted.

FIG. 6 is a perspective view of the substrate 150 to which the transformer assembly 100 shown in FIG. 1 can be mounted. FIG. 7 is a perspective view of an electrical assembly 200 that includes the transformer assembly 100 shown in FIG. 1 mounted to the substrate 150 shown in FIG. 6. FIGS. 11A and 11B show transformer windings 220 and connections between the transformer assembly 100 shown in FIG. 1 and the substrate 150 shown in FIG. 6.

As shown in FIG. 6, the substrate 150 includes a notch 155 that receives the peg 125 of the clip 120 to locate the transformer assembly 100 on the substrate 150. The substrate 150 also includes recesses 153 that receive the mounting brackets 123 of the clip 120 to secure the transformer assembly 100 to the substrate 150, as shown in FIG. 7.

After the transformer assembly 100 is located and secured to the substrate 150, the transformer windings 220 are wrapped around winding pins 151 connected to the substrate 150 by machine winding or hand winding, as shown in FIGS. 11A and 11B. The transformer windings 220 are then soldered to corresponding pads 152 on the substrate 150 by machine soldering or hand soldering, and an electrical assembly 200 is provided. The transformer windings 220 can be soldered to the winding pins 151 by any suitable method, including, for example, laser soldering, wave soldering, etc. The transformer windings 220 can be connected to the winding pins 151 without any tension in the windings.

The winding pins 151 are not limited in their design and/or shape. For example, FIGS. 6 and 7 show examples of z-shaped or s-shaped winding pins 151 that are surface mounted, which are similar to the pins disclosed in Lee Francis, “SURFACE-MOUNT-ASSEMBLY Z-SHAPED PIN,” U.S. Provisional Patent Application No. 63/041,299, filed on Jun. 19, 2020, and FIGS. 11A and 11B show examples of edge fit winding pins 151 that are pressed onto sides of the substrate 150, which are similar to the pins disclosed in Lee Francis, “EDGE-FIT PINS,” U.S. Provisional Patent Application No. 63/041,499, filed on Jun. 19, 2020. Other types of winding pins may also be used. In addition, the transformer windings 220 may be welded to corresponding pads 152 on the substrate 150. Furthermore, machine soldering or welding is preferred to hand soldering, as hand soldering may cause mechanical weaknesses, for example, thinning or fracturing of the wires included in the transformer windings 220.

As shown in FIGS. 6 and 7, the substrate 150 also includes mounting pins 159 to electrically connect and mount the transformer assembly 100 and substrate 150 to another electrical component, a host substrate, an electrical connector, or the like.

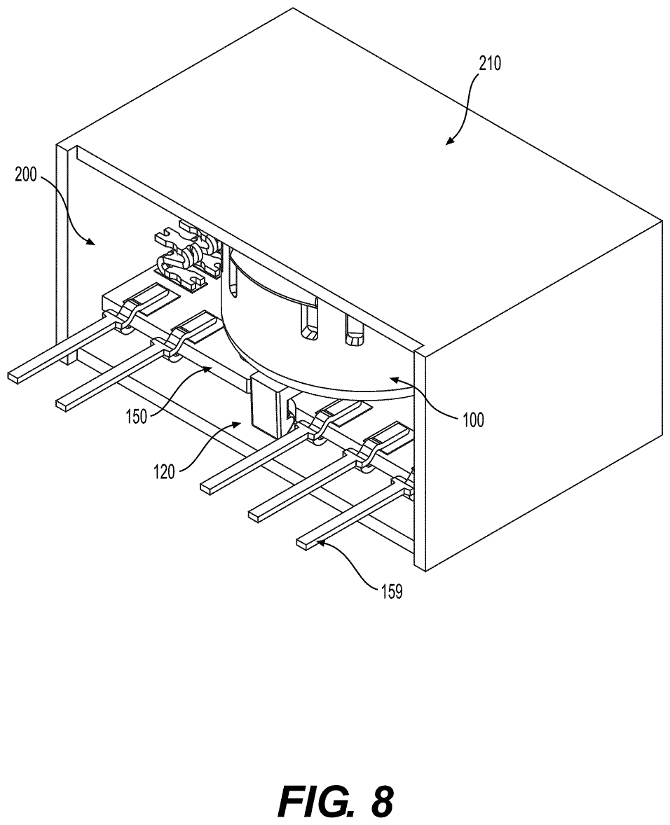

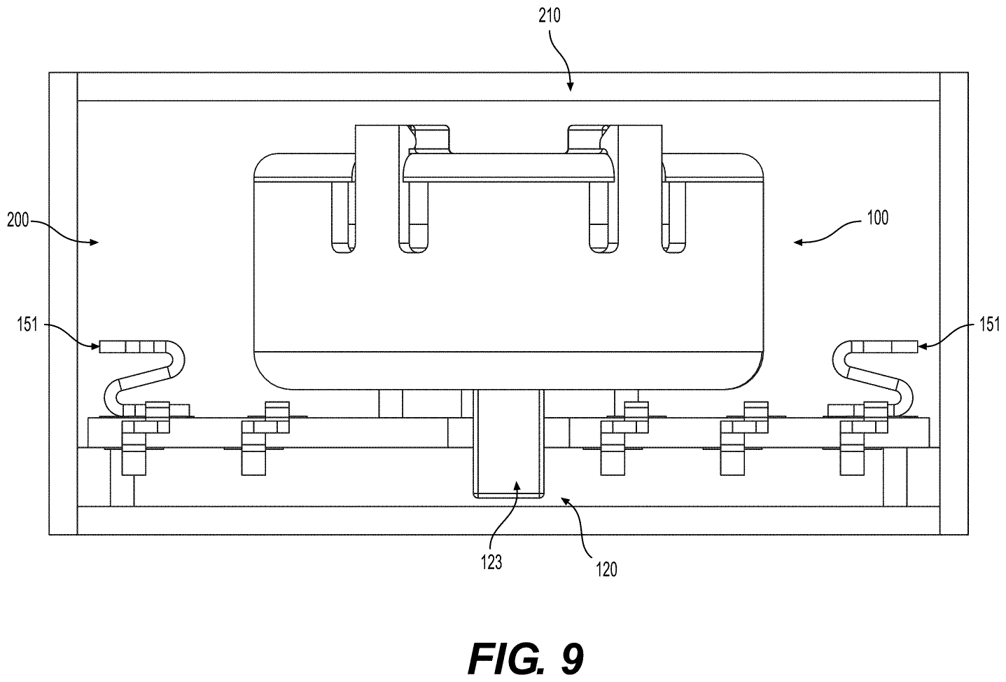

FIGS. 8 and 9 are a perspective view and a side view of the electrical assembly 200 shown in FIG. 7 inserted to the casing 210. FIG. 10 is a perspective view of the electrical assembly 200 and casing 210 shown in FIG. 8 with the edge fit pins shown in FIGS. 11A and 11B.

After the electrical assembly 200 is provided by mounting the transformer assembly 100 to the substrate 150 with the transformer windings 220 connected to the corresponding pads 152 on the substrate 150, the electrical assembly 200 is placed into the casing 210, as shown in FIGS. 8-10.

The casing 210 is then filled with a material, for example, with an epoxy or a silicon material, to encapsulate or pot the transformer assembly 100. In addition to the transformer assembly 100 being mechanically secured to the substrate 150, a space in the center of the transformer core 110 is also filled with the material to further isolate the primary transformer windings from the secondary transformer windings. The material fully can fill the space in the center of the cup 102, and no void space is present in the center of the transformer core 110. The encapsulant or potting material can be chosen to provide the required UL creepage between the core 110 and the transformer windings 220 and between the transformer primary windings and the transformer secondary windings.

As shown in FIGS. 1, 3, 5, and 7, the lid 103 and/or the cup 102 includes at least one hole 109 that exposes the transformer core 110 and that is arranged to allow the material to flow into the cup 102 and the lid 103 to encapsulate or pot the transformer core 110 inside the cup 102 and lid 103. Accordingly, the transformer core 110 can be fully encapsulated or potted. The number of holes 109 included in the cup 102 and lid 103 is not limited. For example, additional holes may be provided in the lid 103 or in the side or bottom of the cup 102, including at locations where the transformer windings 220 are provided.

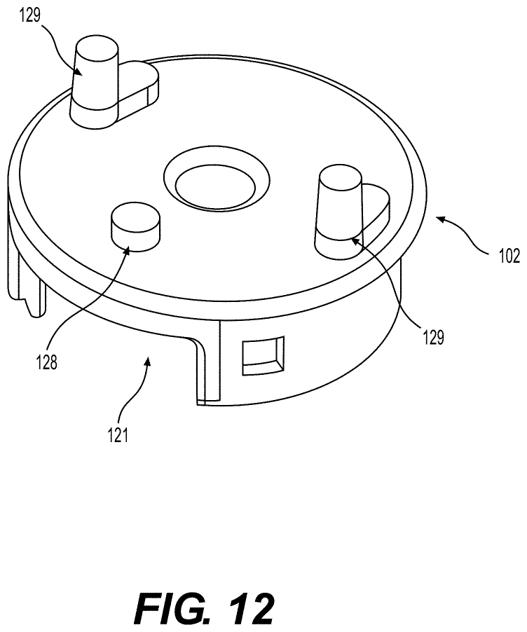

The clip 120 may be omitted from the transformer assembly 100, and a bottom surface of the cup 102 may include pips or feet that mate with corresponding recesses 153 or through-holes in the substrate 150 to locate the transformer assembly 100 on the substrate 150. FIG. 12 shows an example of a pip 128 and feet 129 that may be provided on the bottom surface of the cup 102 of the transformer assembly 100. In addition, double-sided tape or the like may be provided to secure the transformer assembly 100 to the substrate 150. Alternatively, the transformer assembly 100 could be held in place by a magnet during the encapsulation or potting process. FIG. 12 also shows that an opening 121 may be provided in a side surface of the cup 102 to provide access to the transformer core 110.

The transformer windings 220 can be easily wound around the cup 102 and lid 103 by machine winding or hand winding due to the large space provided by the center hole 102H of the cup 102 and the center hole 103H of the lid 103. Physical separation and further electrical isolation of the primary and secondary transformer windings 220 may then be provided by inserting the clip 120 into the center hole 102H of the cup 102. The clip 120 can also provide a secure physical connection between the transformer assembly 100 and the substrate 150 while the transformer windings 220 are soldered or welded to corresponding pads 152 on the substrate 150. In contrast, the known transformer assembly shown in FIG. 13 includes an isolation barrier that is molded into the cup 102, which makes winding the transformer windings 220 difficult and necessitates hand winding. The known transformer assembly shown in FIG. 13 may also be difficult to secure to the substrate 150 while the transformer windings 220 are soldered to corresponding pads 152 on the substrate 150, in contrast to the transformer assembly 100 according to a preferred embodiment of the present invention.

The transformer core 110 can be encapsulated or potted after the transformer windings 220 have been wound. Accordingly, a single encapsulating or potting process may be implemented to secure the transformer core 110 inside the cup 102, fill any void space in the center holes 102H and 103H of the cup 102 and lid 103, and further secure the transformer assembly 100 to the substrate 150. Thus, manufacturing efficiency is significantly increased while also significantly reducing cost.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

1. A transformer assembly comprising:
a transformer core;
a cup that receives the transformer core;
a lid that engages with the cup and covers the transformer core; and
a winding wound around the cup and the lid; wherein
the cup and/or the lid include at least one hole through which the transformer core is exposed to an exterior of the cup and the lid when the lid is engaged with the cup; and
the at least one hole is located in the cup and/or lid where the winding is wound around the cup and the lid.

2. The transformer assembly according to claim 1, further comprising a clip that is at least partially inserted into a center hole of the cup.

3. The transformer assembly according to claim 2, wherein the clip includes at least one clasp that engages with a recess of the cup.

4. The transformer assembly according to claim 2, wherein the clip includes a peg or a bracket that engages with a corresponding notch or recess in a substrate to secure the transformer assembly to the substrate.

5. The transformer assembly according to claim 2-4, wherein the clip includes an injection-molded plastic.

6. The transformer assembly according to claim 1, wherein a bottom surface of the cup includes pips or feet that locate the transformer assembly with respect to a substrate.

7. The transformer assembly according to claim 1, further comprising a substrate located in a center hole of the cup; wherein
a material of the substrate is FR4.

8. (canceled)

9. The transformer assembly according to claim 1, wherein each of the cup and the lid includes a center hole with a diameter of about 2 mm or greater.

10. An electrical assembly comprising:
the transformer assembly according to claim 1;
a substrate; and
a casing that at least partially surrounds the transformer assembly and the substrate, wherein
the transformer assembly is mounted to the substrate,
the winding includes first and second transformer windings that are electrically connected to corresponding pads on the substrate, and
the casing includes a material to encapsulate or pot the transformer assembly.

11. A method of assembling and mounting a transformer, the method comprising:
placing a transformer core inside a cup;
covering the transformer core with a lid;
wrapping a primary transformer winding and a secondary transformer winding around the cup and the lid;
mounting the cup to a substrate; and
encapsulating or potting the transformer core after the cup has been mounted to the substrate.
